(19) United States
(12) Patent Application Publication
(10) Pub. No.: US 2025/0316825 A1
(43) Pub. Date: Oct. 9, 2025

(54) Electrical Connector for High Voltage Cables

(71) Applicant: Caterpillar Inc., Peoria, IL (US)

(72) Inventors: Brian R. Bell, West Lafayette, IN (US); Timothy R. Beetler, Peoria, IL (US); C. Brahm Landis, Indianapolis, IN (US); Allen B. Chu, Dunlap, IL (US); Ian A. Tiggemann, Peoria, IL (US); Adam R. Vail, Aurora, IL (US)

(73) Assignee: Caterpillar Inc., Peoria, IL (US)

(21) Appl. No.: 18/630,711

(22) Filed: Apr. 9, 2024

(51) Int. Cl. H01M 50/296; H01M 50/271; H01M 50/298; H01R 13/53

(52) U.S. Cl. CPC H01M 50/296; H01M 50/271; H01M 50/298; H01R 13/53

(57) ABSTRACT

An electrical connector for the high voltage electrical connection of electrical cables to a battery pack can be selectively configured to align the electrical cables in multiple directions. The electrical connector includes a box frame mountable to the battery pack and having one or more frame faces with an access opening therein that accesses a terminal receiving cavity of the box frame. A cable receiving housing is attachable to the frame face and configured to align and direct the electrical cables to the terminal receiving cavity. A cover plate may be used to cover the access opening in the others frame faces.

### TECHNICAL FIELD

This patent disclosure relates generally to an electrical connector for connecting high voltage cables to a battery pack and, more particularly, to an electrical connector that can be selectively configured for multiple cable alignments.

### BACKGROUND

High voltage battery packs provide significant electrical power for various types of machines including increasingly mobile machines used in industries such as mining, construction, landscaping, and agriculture. The battery pack includes several individual electrochemical cells accommodated and electrically connected together in a battery casing. The individual electrochemical cells can be connected in series or parallel to deliver the voltage and current needed for the intended application. The electrochemical cells are typical rechargeable for repeated use and may have, for example, a lithium ion battery chemistry. To connect the battery pack with an electrical load, which in the case of mobile machines may be an electrical motor operating on direct current, the battery pack is configured with external terminals or connectors accessible on the exterior of the battery casing.

In high voltage applications involving the distribution of significant voltage and current, the external terminals from the battery pack may be configured as busbars, which are conductive metallic bars of a significant thickness and cross-section to effectively conduct electrical current. The busbars may be flat and rigid with substantial surface area so that they may make abutting contact with a connecting terminal for the transfer of electrical power. The connecting terminal can be fastened to the busbar with fasteners for a robust semi-permanent connection.

Also in high voltage applications, high voltage electrical cables are typically used to transmit electrical power from the battery pack to the electrical load. The external electrical connector can be configured to interface with the electrical cables to establish electrical connection with the battery pack. U.S. Pat. No. 10,868,388 describes a high voltage electrical connector for a battery pack configured to receive one or more electrical cables. The electrical connector has a low profile for improved space utilization and is configured to align with the electrical cables running adjacently along the battery casing.

The present disclosure is directed to an electrical connector for high voltage cables that is adaptable for a plurality of different connection alignments.

### SUMMARY

The disclosure describes, in one aspect, an electrical connector for the high voltage connection of electrical cables to a battery pack. The electrical connector includes a box frame defining a terminal receiving cavity and at least a first frame face having a first access opening to the terminal receiving cavity disposed therein. Attachable to the box frame is a cable receiving housing having disposed therein a first cable port and a second cable port for receiving electrical cables, the cable receiving housing is attachable to the first frame face to direct the electrical cables into the terminal receiving cavity.

In another aspect, the disclosure describes a method of establishing an electrical connection of electrical cables to a battery pack. The method includes mounting a box frame having a terminal receiving cavity to a battery casing of the battery pack so as to accommodate a first battery terminal and a second battery terminal within the terminal receiving cavity. A first battery cable and a second battery cable are inserted respectively through a first cable port and a second cable port located in a cable receiving housing and into the terminal receiving cavity through an access opening defined in a first frame face on the box frame. The cable receiving housing can then be attached to the first frame face to align the first electrical cable and the second electrical cable with respect to the terminal receiving cavity.

In a further aspect, the disclosure describes a battery pack including a battery casing enclosing a plurality of electrical chemical cells with first and second busbar terminals protruding externally from the battery casing. To connect electrical cables with the first and second busbar terminals, an electrical connector is mounted to the battery casing so as to enclose the electrical connection. The electrical connector includes a box frame that mounts to the battery casing to accommodate the first and second busbar terminals inside a terminal receiving cavity defined by the box frame. Attachable to the box frame can be a cable receiving housing configured to mount to a first frame face of the box frame. The cable receiving housing includes a first cable port and a second cable port for insertion and alignment of the first electrical cable and the second electrical cable with respective to the first busbar terminal and the second busbar terminal that are accommodated in the terminal receiving cavity.

### BRIEF DESCRIPTION OF THE DRAWINGS

FIG. 1 is a perspective view of an electrical connector mounted to the exterior of a prismatic battery pack with a cable receiving housing that may be selectively oriented for multiple cable alignments.

FIG. 2 is a perspective view of the electrical connector with the cable receiving housing configured in a vertically upward direction to receive high voltage cables extended in a vertical alignment.

FIG. 3 is a perspective view of the electrical connector with the cable receiving housing configured in a vertically downward direction to receive high voltage cables extended in a vertical alignment.

FIG. 4 is an exploded view of the component parts of the electrical connector that can be selectively assembled for interfacing with multiple cable alignments.

FIG. 5 is a frontal perspective view of the cable receiving housing showing the parallel first and second cable ports disposed into the forward shell face of the receptacle shell.

FIG. 6 is a rearward perspective view of the cable receiving housing showing the interior shell cavity defined by the receptacle shell.

FIG. 7 is a frontal perspective view of the box frame showing orthogonally arranged frame faces for attachment with the cable receiving housing.

FIG. 8 is a rear perspective view of the box frame showing the busbar access face including parallel first and second busbar access slots.

FIG. 9 is an assembly view of the mounting plate for mounting to the casing of battery pack in relation to the busbar terminals and busbar insulators.

FIG. 10 is an assembly view of the box frame in relation to a first check plate and a second check plate located respectively between an upward cover plate and a downward cover plate.

FIG. 11 is a front perspective view of an embodiment of an angled adapter having a housing attachment face and a frame attachment face orthogonally arranged with respect to each other.

FIG. 12 is a rear perspective view of the angled adapter showing the adapter cavity partially enclosed by an adapter canopy.

FIG. 13 is a perspective view of the electrical connector including the angled adapter assembled with the box frame and the cable receiving housing mounted to the exterior of a prismatic battery pack.

FIG. 14 is a perspective view of the electrical connector assembled in accordance with FIG. 13 without the angled adapter to show the electrical connection between the high voltage cables and the busbar terminals.

### DETAILED DESCRIPTION

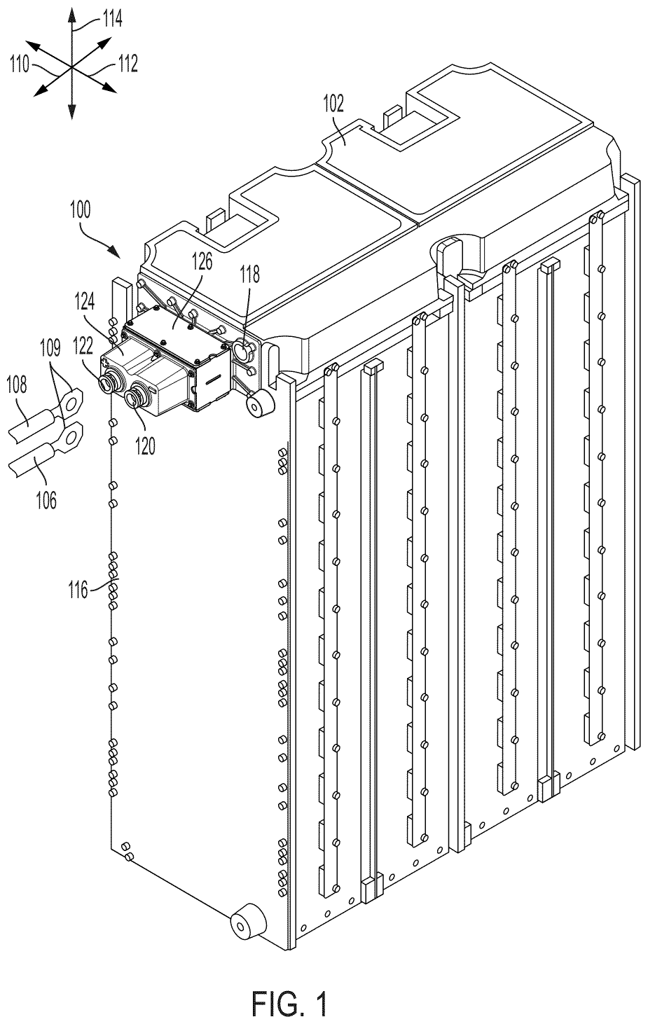

Now referring to the drawings, wherein whenever possible like reference numbers will refer to like elements, there is illustrated in FIG. 1 an external electrical connector 100 mounted to a rechargeable battery pack 102 for the supply of high voltage, high current electrical power. The battery pack 102 can include an external battery casing 104 that accommodates a plurality of individual electrochemical cells for the generation of electricity for delivery to and powering an electrical load. By way of example, the electrical load may be a direct current electrical motor for the propulsion of a mobile machine. In the present example, the battery pack 102 may be one of several battery packs to provide the needed voltage and current for operation of the mobile machine over a significant duration of time before recharging is required. However, aspects of the disclosure are applicable to electrical connectors 100 and battery packs 102 for any suitable high voltage, high current application. By way of example, the current and voltage provided by the battery pack 102 can be on the order of 1500 volts and 300 amps, as may be utilized in mobile machines and electrical vehicles.

In such high voltage, high current applications, the battery packs 102 may be electrically connected to the load by one or more high voltage electrical cables, for example, a first electrical cable 106 and a second electrical cable 108 for establishing a direct current circuit between the battery pack and the load. The electrical cables 106, 108 can be flexible to facilitate routing and may include a central conductor that is encased in an insulating sheath or cover, for example, made of PVC or similar material. The distal end of the central conductor may terminate at a terminal that is configured for connection with the corresponding terminals of the battery pack 102. In the illustrated embodiment, the terminal can be a terminal lug 109 of a flat conductive metal with a central aperture disposed there through. A threaded fastener can be inserted through the aperture to fasten the terminal lug 109 adjacent to a conductive support structure on the battery pack 102.

In the illustrated embodiment, the battery pack 102 can be a prismatic battery in which the external battery casing 104 is rectangular in shape to accommodate the stacking of multiple individual cells; however, aspects of the disclosure may be applicable to battery packs of other configurations wherein the external battery casing can be round or have other geometric shapes. For durability, the battery casing 104 can be assembled of metal or plastic sheets or plates and may incorporate insulators for electric protection. The external battery casing 104 provides an environmentally tight housing to prevent exposure of the internally accommodated electrochemical cells to moisture or the atmosphere, which may adversely affect the chemical constituents of the electrochemical cells. The dimensions of the external battery casing 104 can conform to design standards or the like to facilitate incorporation of the battery pack 102 into a mobile machine.

For reference purposes, the three-dimensional rectangular shape of the battery pack 102 can establish a reference system or coordinate system. The coordinates may include a longitudinal or forward-aft direction 110 associated with the longitudinal length of the battery pack 102 and a lateral direction 112 perpendicular to the forward-aft direction and associated with the width of the battery pack 102. In addition, a vertical direction 114 can be normal to the forward-aft direction 110 and the lateral direction 112 and can be associated with the height of the battery pack 102.

In the configuration of a prismatic battery pack 102, the electrical connector 100 can be located at an upward corner of the battery casing 104 and mounted to a forward planar casing face 116 that is oriented orthogonally to the forward-aft direction 110. To receive and mate with the first and second first and second high voltage electrical cables 106, 108, the electrical connector 100 can include a first cable gland 120 and a second cable gland 122, which may also be referred to as cable strain reliefs. The cable glands 120, 122 secure and seal the electrical cables 106, 108 and enable feed through access for the electrical cables into the battery casing 104. In addition to connecting with the electrical cables, the electrical connector 100 may be associated with a battery management system (BMS) interface 118 that functions as a communication port to transfer data about the electrical operating or charging conditions of the battery pack 102.

The electrical connector 100 can be arranged to align with and receive the first and second high voltage electrical cables 106, 108 that may extend along and be aligned with the forward-aft direction 110, which thus corresponds with the insertion axis or cable approach. The electrical connector 100 can be accordingly mounted to the battery casing 104 with the first and second cable glands aligned in the forward-aft direction 110. However, different cable alignments may be desired depending upon the application and positioning of the battery pack 102. The electrical connector 100 is therefore designed for selective configuration to accommodate a variety of different cable alignments and directions.

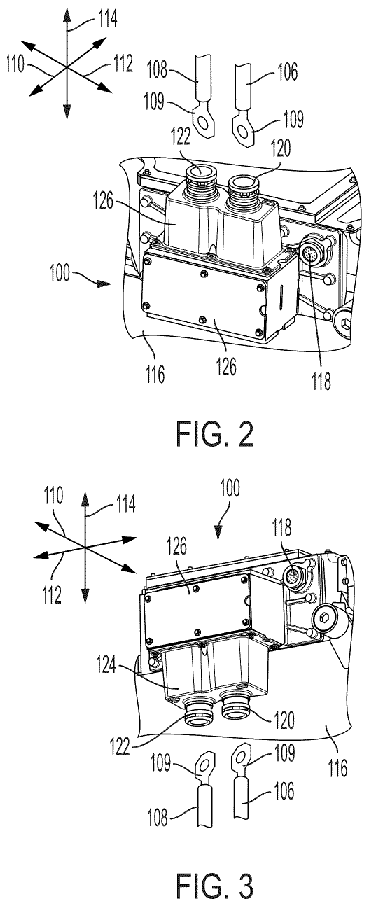

To enable the selective configuration of the electrical connector 100, the electrical connector can be a multipart assembly including a variably positioned cable receiving housing 124 that attaches to a box frame 126 that is fixedly mounted to the forward planar casing face 116. For example, referring to FIG. 2, the cable receiving housing 124 can be attached to an upper face of the box frame 126 so that cable glands 120, 122 are aligned in the vertical direction 114 and can receive downwardly extending electrical cables 106, 108 also aligned in the vertical direction 114. Alternatively, referring to FIG. 3, the cable receiving housing 124 can be attached to an lower face the box frame 126 to receive electrical cables 106, 108 extending upwardly along and aligned with the vertical direction 114.

For durability and rigidity, the cable receiving housing 124 and the box frame 126 can be metal that may be cast or sintered to the appropriate shape. The metallic components can withstand forceful impacts to which the electrical connector 100 may be exposed due to external mounting on exterior of the battery casing. However, in other embodiments, other materials may be selected for the cable receiving housing 124 and the box frame 126 such as molded thermoplastic or 3-D printing resins.

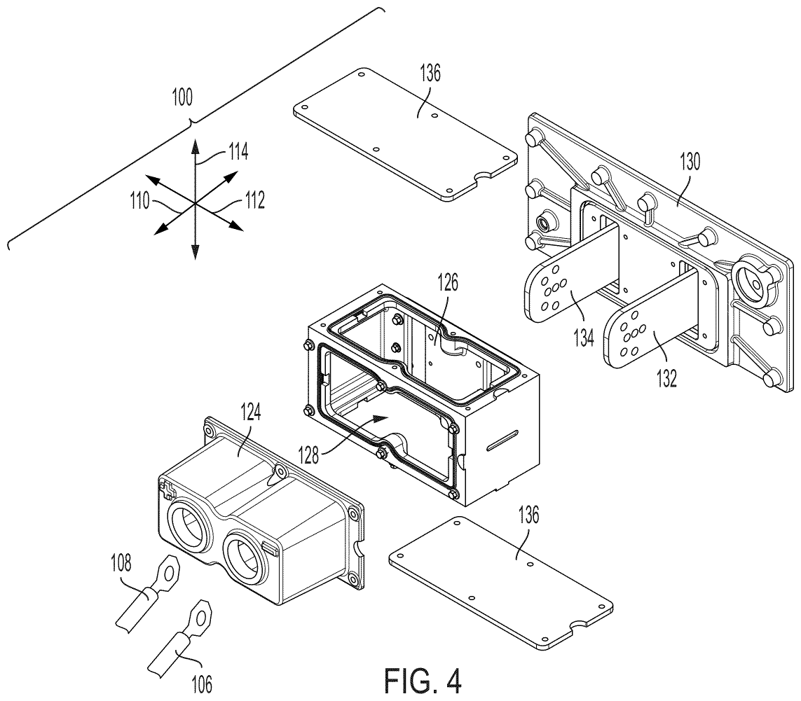

To selectively attach the cable receiving housing 124 to the box frame 126, as shown in FIG. 4, the box frame 126 is shaped as a cubic rectangle with a plurality of orthogonally arranged faces that define a hollow, terminal receiving cavity 128. The box frame 126 can be mounted to a mounting plate 130 on the battery casing. First and second busbar terminals 132, 134, which may be rigid conductive lugs of the type described above, project in the forward-aft direction 110 from the mounting plate 130. The first and second busbar terminals 132, 134 are parallel and laterally spaced apart, and project into the terminal receiving cavity 128 from the rear of the box frame 126.

The cable receiving housing 124 can be selectively attached to any of the three un-occluded rectangular faces of the box frame 126, each of which defines an access opening for the electrical cables to extend through into connection with the busbar terminals 132, 134 located in the terminal receiving cavity 128. To close the remaining faces of the box frame 126 that are not attached with the cable receiving housing 124, the multipart electrical connector 100 can include first and second rectangular cover plates 136 that are planar in shape and can adjacently abut the box frame 126.

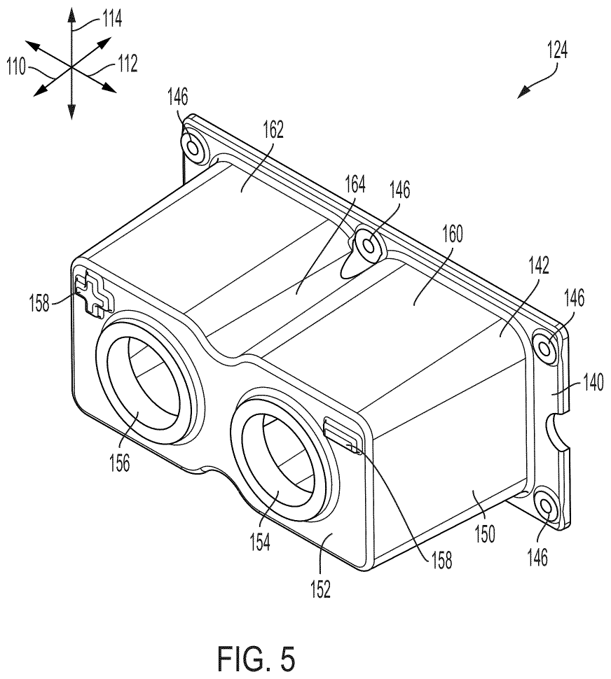

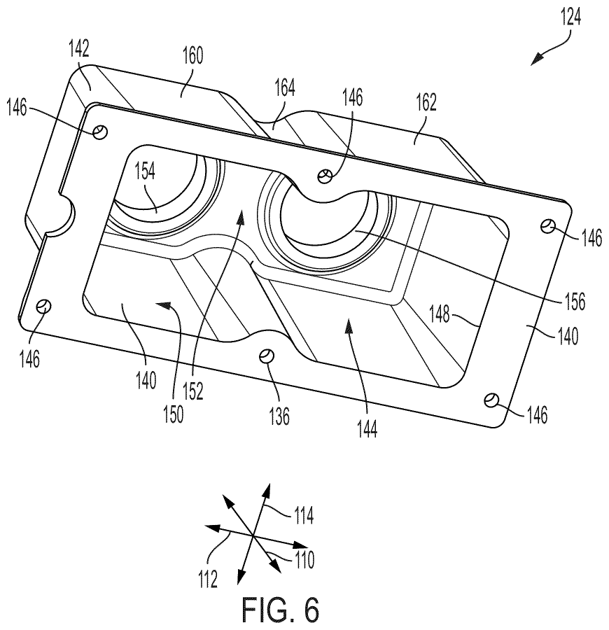

Referring to FIGS. 5 and 6, and for reference purposes, the cable receiving housing 124 can have a generally rectangular three-dimensional extension in the forward-aft direction 110, lateral direction 112, and vertical direction 114. The cable receiving housing 124 includes a peripheral attachment rim 140 that serves as a base from which protrudes a hollow receptacle shell 142 that defines a cable receiving shell cavity 144. The peripheral attachment rim 140 can be planar with respect to the lateral and vertical directions 112, 114 such that it is normal to the forward-aft direction 110. The planar structure of the peripheral attachment rim 140 allows for abutting contact against the flat faces of the box frame 126 when attached thereto. To attach the cable receiving housing 124 to the box frame 126 with threaded fasteners, a plurality of fastener openings 146 can be disposed normally through the peripheral attachment rim 140

The peripheral attachment rim 140 defines a rectangular, or four-sided, outline that circumscribes and spatially extends outward from the base of the receptacle shell 142. The peripheral attachment rim 140 also outlines and defines a receptacle shell opening 148 for access to the shell cavity 144 defined by the receptacle shell 142.

The receptacle shell 142 includes a shell skirt 150 extending from the planar peripheral attachment rim 140 with respect to the forward-aft direction 110 and that terminates at a planar shell face 152 that is normal to the shell skirt 150 and parallel to the peripheral attachment rim 140. The planar shell face 152 is arranged normal to the forward-aft direction 110 and is situated in the plane defined by the lateral and vertical directions 112, 114. The shell skirt 150 and the planar shell face 152 are thin-walled structures situated about and enclosing the shell cavity 144.

To receive the electrical cables, there are disposed into the planar shell face 152 a first cable port 154 and a second cable port 156 providing access to the shell cavity 144. The first and second cable ports 154, 156 are laterally offset from each other with respect to the lateral direction 112. The first and second cable ports 154, 156 are circular in shape and can secure to the cable glands 120, 122 shown in FIGS. 1-3, for example, via a compression fitting included on the cable glands. The orientation of the openings defined by the first and second cable ports 154, 156 therefore establishes the cable alignment and direction of cable connection of the electrical connector 100. In embodiment, to facilitate insertion and connection of the electrical cables, the planar shell face 152 can include positive and negative polarity indicia 158 formed as a raised relief thereon.

In a further embodiment, the rectangle shape of the receptacle shell 142 can be further comprised of a first cubic lobe 160 associated with the first cable port 154 and a second cubic lobe 162 associated with the second cable port 156. The first and second cubic lobes 160, 162 are thus laterally adjacent to each other and provide the lateral opposite sides of the receptacle shell 142. The laterally adjacent first and second cubic lobes 160, 162 are joined at a shell neck 164 that is formed in the shell skirt 150. For example, the shell neck 164 can be formed where the laterally extending and otherwise parallel thin walls of the shell skirt 150 deviate toward each other, thereby necking the shell skirt 150. The shell neck 164 can be located between the first and second cable ports 154, 156 and thus at the lateral midpoint of the receptacle shell 142.

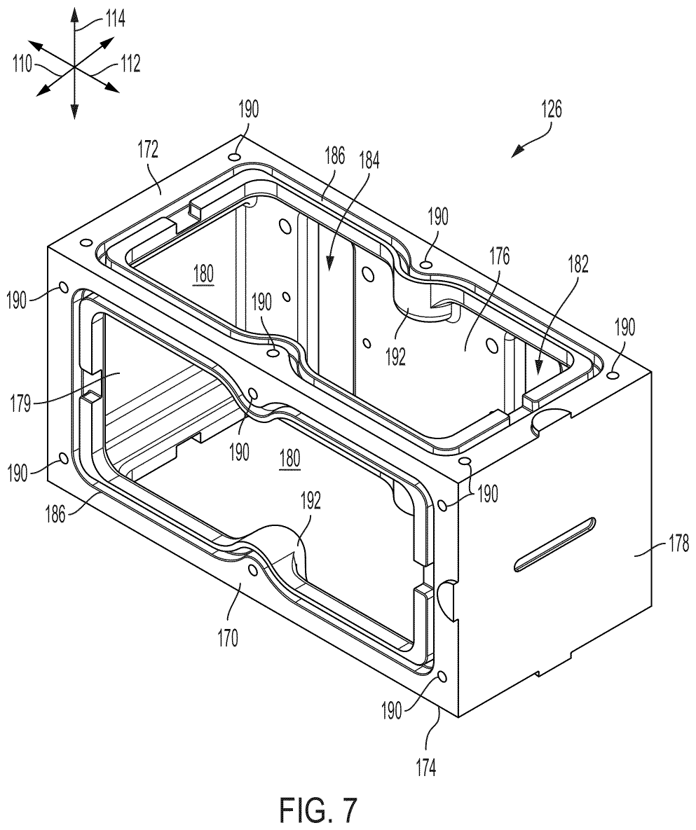

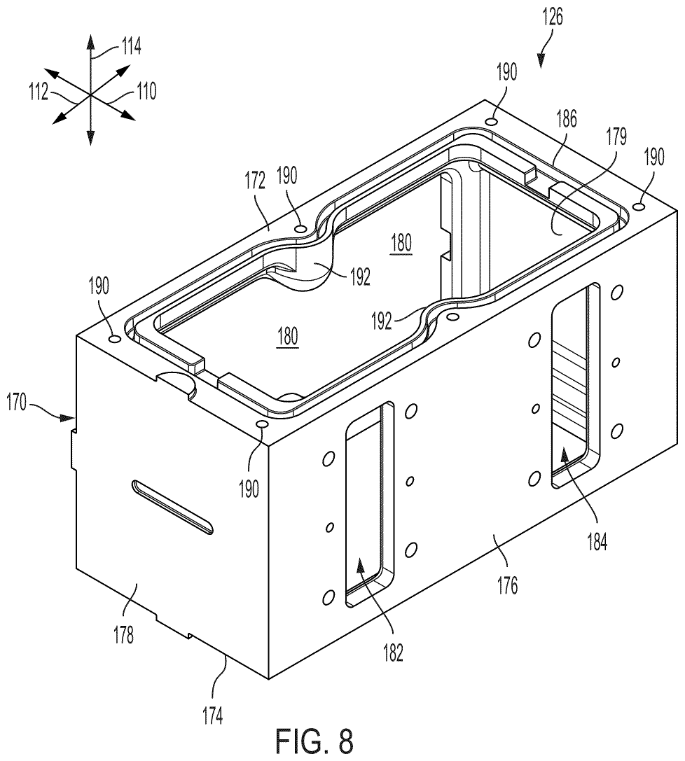

Referring to FIGS. 7 and 8, the box frame 126 is shaped as a multisided cubic rectangle with three of the longer rectangular faces configured as first, second, and third frame faces 170, 172, 174 and the fourth rectangular face configured as a mounting face 176. The forward facing first frame face 170 may be parallel and spaced from the rearward mounting face 176 with respect to the forward-aft direction 110 and the second and third frame faces 172, 174 may be respectively designated upper and lower frame faces with respect to the vertical direction 114. The orthogonally arranged frame and mounting faces intersect at 90° angles to surround the terminal receiving cavity 128 defined by the box frame 126. The opposing lateral ends of the box frame 126 can be enclosed by first and second lateral side panels 178, 179 that are perpendicular to the frame faces 170, 172, 174 and mounting face 176.

The first, second and third frame faces 170, 172, 174 each has a planar, flat exterior surface with an access opening 180 disposed there through that may conform in rectangular shape to the rectangular box frame 126 and that establish spatial access to the terminal receiving cavity 128. The mounting face 176 can be configured as a planar partition or wall for mounting adjacent to the battery casing and can have a first busbar access aperture 182 and a second busbar access aperture 184 disposed therein. To conform in shape and arrangement to the busbar terminals, the first and second busbar access apertures 182, 184 can be rectangular in shape, laterally offset and extending in parallel to each other with respect to the vertical direction 114.

In an embodiment, to create environmentally sealed attachments, the frame faces 170, 172, 174 can each include a three-sided seal groove 186 that is disposed into the exterior surface and that circumscribes the respective access opening 180. The seal groove 186 can assume a generally rectangular outline conforming to the rectangular access opening 180. The three-sided seal groove 186 can accommodate a sealing ring or press-in-place seal made of a loop of elastomeric material configured with a cross-section enabling the seal to urge against a planar surface placed adjacent to the frame faces 170, 172, 174.

To secure the box frame 126 with the other components of the electrical connector 100, a plurality of fastener openings 190 can be disposed into the planar surfaces of the first, second and third frame faces 170, 172, 174. In the illustrated embodiment, a total of six fastener openings 190 can be arranged at the corners and lateral midpoints of each of the frame faces 170, 172, 174, although other arrangements and numbers of fastener openings are contemplated. In a particular embodiment, the frame faces 170, 172, 174 may each include a fastener boss 192 that protrudes form the perimeter defined by the frame faces into the access openings 180. The fastener bosses 192 can be associated with fastener openings 190 that are located at the mid-lateral position of the longitudinal edges of the frame faces 170, 172, 174, and thus provide a material anchorage into which the fasteners can be secured.

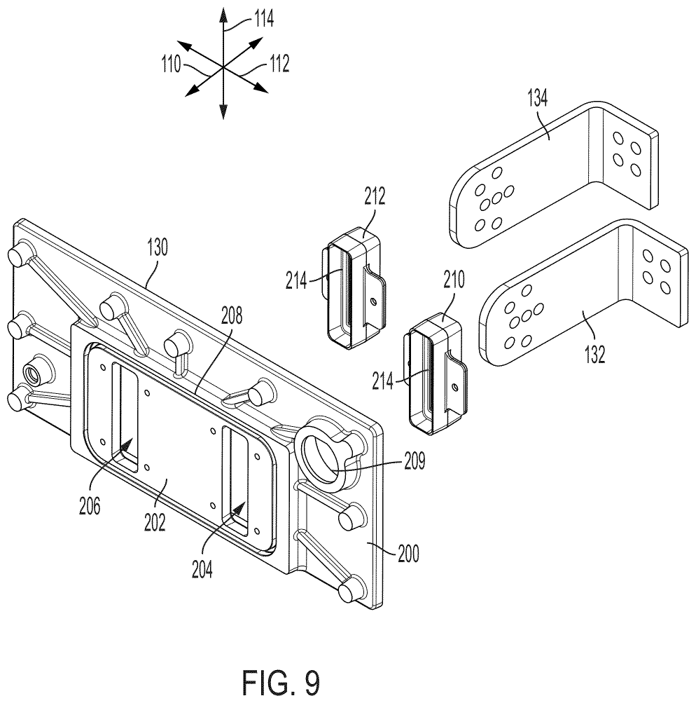

Referring to FIG. 9, the mounting plate 130 can be generally flat and rectangular in shape and can be a separate part secured to the battery casing, although in other embodiments the mounting plate 130 can be integrally formed into the battery casing. To abut against the battery casing, the mounting plate 130 can have a flat planar case surface 200 situated in the plane defined by the lateral and vertical direction 112, 114 and an oppositely located elevated mounting boss 202 formed as a raised relief extending from the planar case surface 200. The planar case surface 200 and the elevated mounting boss 202 are thus normal to the forward-aft direction 110.

The elevated mounting boss 202 can be rectangular and coextensive in shape with the mounting face 176 of the box frame 126. The planar case surface 200 can also be shaped as a larger rectangle extending in the lateral and vertical directions 112, 114 beyond the outline defined by the elevated mounting boss 202. The planar case surface 200 therefore can provide an enlarged structural flange extending about the elevated mounting boss 202 to abut adjacently with and attached to the exterior surface of the battery casing.

To allow passage of the first and second busbar terminals 132, 134, the mounting plate 130 includes respective first and second busbar slots 204, 206 disposed between the planar case surface 200 and the elevated mounting boss 202. The first and second busbar slots 204, 206 are laterally offset with respect to the lateral direction 112 and are rectangular in shape extending with respect to the vertical direction 114.

To seal against the adjoining box frame 126, the elevated mounting boss 202 can include a three-sided seal groove 208 disposed into the exterior surface that rectangularly circumscribes the first and second busbar slots 204, 206 and can accommodate a ring seal or press-in-place seal. In an embodiment, to provide access for the BMS interface, the mounting plate 130 can also include a circular interface aperture 209 disposed through the planar case surface 200 therein and offset from the elevated mounting boss 202.

To electrically insult the mounting plate 130 from the conductive busbar terminals 132, 134, which as shown in FIG. 9 are L-shaped metallic lug bars, the first and second busbar slots 204, 206 can attach to first and second busbar insulators 210, 212. The busbar insulators 210, 212 can be a rectangular profile each defining and outlining an aperture 214 for the busbar terminals 132, 134 to pass through and can be made of an elastomeric or other insulating material. The busbar insulators 210, 212 can be press fit into the respective busbar slots 204, 206 or can be secured proximately thereto by fasteners.

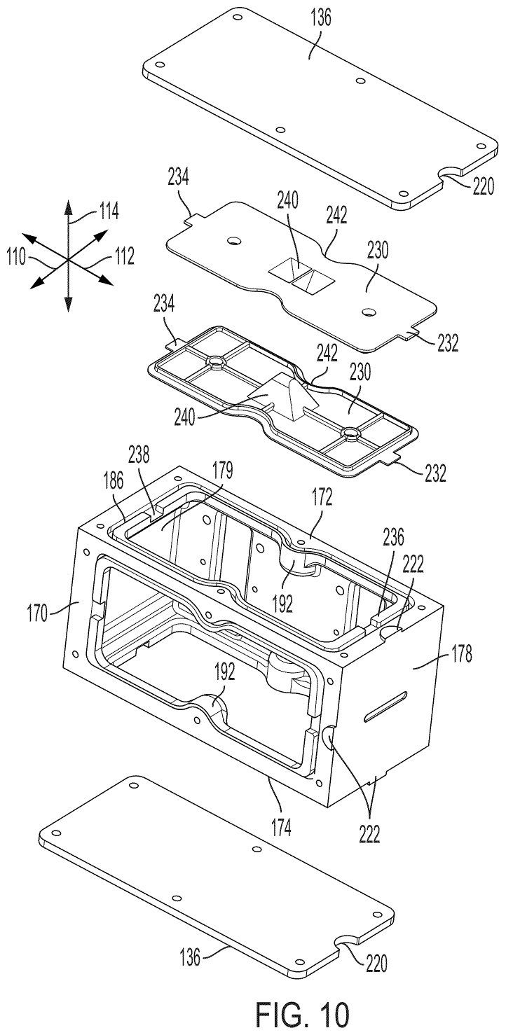

Referring to FIG. 10, the cover plates 136 are flat planar structures to cover the exposed access openings 180 of the frame faces that are not attached with the cable receiving housing. The cover plates 136 can be rectangular conforming in shape and dimension with the rectangular outline of the frame faces 172, 174 to which they are attached. Flat shape of the cover plates 136 enables them to contact and compress the seals accommodated in the seal grooves 186 disposed into the frame faces 172, 174. In an embodiment, the cover plates 136 can be made of metallic stampings.

In an embodiment, to facilitate attachment of the cover plates 136 to the box frame 126, one of the lateral edges of the cover plates 136 can include an alignment notch 220 that is configured to mate with a corresponding alignment boss 222 formed on each of the frame faces 170, 172, 174. The alignment boss 222 is provided only on the frame face proximate with the intersection to one of the lateral side panels 178, 179, for example, the first side panel 178. Inclusion of a single alignment notch 220 and the corresponding alignment boss 222 correctly aligns the cover plates 136 with the box frame 126 during attachment.

In an embodiment, to further enclosure of the unoccupied access openings 180 in the plurality of frame faces 170, 172, 174, the electrical connector 100 can include one or more check plates 230 that engage with the box frame 126. The check plates 230 can be configured as rectangular panels and can be geometrically shaped and dimensionally correspond with the outline of the access openings 180. The check plates 230 can be made from a thermoplastic, non-conductive material.

To align the check plates 230 within the access openings 180, the check plates 230 can include first and second clip tabs 232, 234 projecting from the opposite lateral edges of the rectangular perimeter. The clip tabs 232, 234 can be configured to snap fit with one or more correspondingly shaped tab recesses 236, 238 disposed into the frame faces 170, 172, 174. The tab recesses 236, 238 can be laterally offset with respect to the lateral direction 112. The tab recesses 236, 238 are shaped and dimensioned to correspond with and receive the clip tabs 232, 234 that project from the lateral edges of the perimeter of the check plates 230, thus establishing alignment of the check plates 230 with respect to the access openings 180.

To facilitate installing the check plates 230 into the access openings 180, a pinch grip 240 can be formed into the planar structure of each of the check plates 230. The pinch grips 240 can be formed as two adjacent depressions separated by a structural wall that can be grasped by opposing fingers. The pinch grips 240 can be located at the mid lateral position of each of the check plates 230.

In the embodiments wherein the frame faces 170, 172, 174 each include a mid-lateral fastener boss 192 protruding into the access openings 180, each of the check plates 230 can include a plate neck 242 that is formed into the elongated longitudinal edges of the check plate 230 to correspond in location with the mid-lateral position of the fastener bosses 192. The plate necks 242 allow a fastener installed through the fastener openings 190 of the cover plate 136 to pass adjacent to the check plate 230 without penetration or damage and into fastener openings 190 in the fastener bosses 192 of the box frame 126.

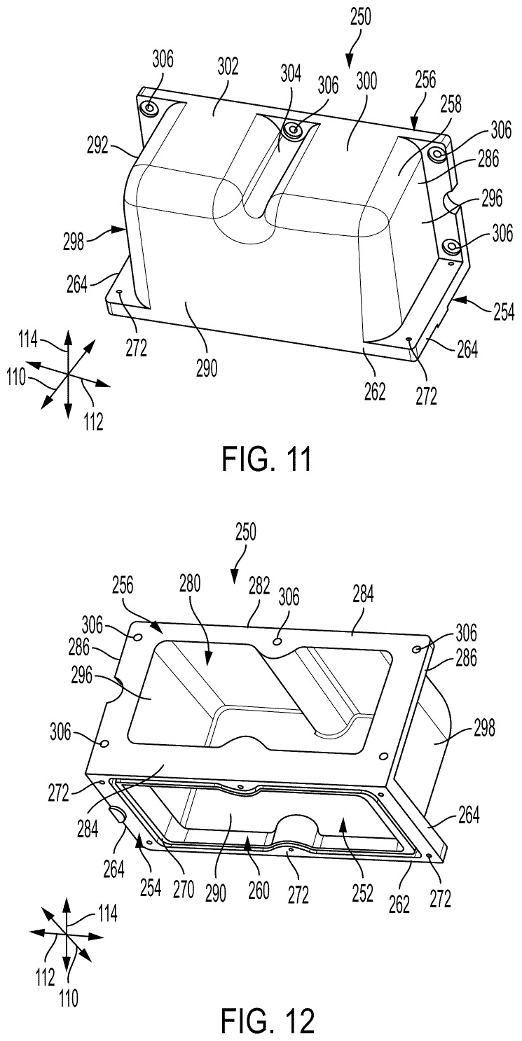

In another embodiment, the multipart electrical connector 100 can include interchangeable components to establish fixed alignment of the electrical cables 106, 108 with respect to the battery pack 102 and the referenced coordinate system. For example, a common orientation is to extend the electrical cables 106, 108 in the vertical direction 114 adjacent to a planar casing face of the external battery casing 114 to facilitate packing of a plurality of battery packs 102 in a confined arrangement. Therefore, referring to FIGS. 11 and 12 to establish the fixed alignment of the electrical cables in the vertical direction, the electrical connector 100 can include an angled adapter 250 configured to situate the angularly perpendicular arrangement of the electrical cable 106, 108 with respect to the busbar terminals protruding from the battery casing 104. The angled adapter 250 can be an additional component of the electrical connector intermediately situated between the cable receiving housing 124 and the box frame 126.

Referring to FIGS. 11 and 12, there is shown an example of the angled adapter 250 that can be configured as a box shaped cuboid generally enclosing and defining an internal adapter cavity 252 for housing the physical connection between the electrical cables and busbar terminals. To interface with the other components of the electrical connector when assembled, the angled adapter 250 can include a first housing attachment face 254 and a second frame attachment face 256. Consistent with the directional arrangements established by the angled adapter 250, the first housing attachment face 254 and the second frame attachment face 256 can be orthogonally arranged with respect to each other at a perpendicular 90° angle; however, in other embodiment, the housing attachment face 254 and the frame attachment face 256 may be situated at different angular arrangements. To partially enclose the adapter cavity 252, the angled adapter 250 can include an adapter canopy 258 that curves between the divergent edges of the first housing attachment face 254 and the second frame attachment face 256.

The first housing attachment face 254 can be configured to interface with the cable receiving housing 124 described with respect to FIGS. 5 and 6. To abut and contact the cable receiving housing, the first housing attachment face 254 includes a smooth, planar exterior surface with a first adapter opening 260 disposed therein accessing the adapter cavity 252. Consistent with the cubic shape of the angled adapter 250, the adapter opening 260 can have a rectangular outline demarcated by two parallel, longer longitudinal edges 262 and two parallel, shorter lateral edges 264 of the first housing attachment face 254 that are orthogonally arranged with respect to each other.

To seal against the cable receiving housing, the first housing attachment face 254 can include a three-sided seal groove 270 to accommodate an elastomeric seal that is disposed into the exterior surface and that circumscribes the adapter opening 260. Additionally, to secure to the cable receiving housing, a plurality of fastener openings 272 can be formed into the first housing attachment face 254 for engaging a respective plurality of threaded fasteners.

To abut against the box frame 126 mounted to the battery casing 104, the second frame attachment face 256 can also have a smooth, planar exterior surface situated perpendicular to and extending normal with respect to the first housing attachment face 254. In an embodiment, to receive the busbar terminals, the second frame attachment face 256 may define a large, second adapter opening 280 into the adapter cavity 252 that is outlined by a rectangular rim 282. The rectangular rim 282 can be a four-sided structure including two parallel longer longitudinal edges 284 and two parallel shorter lateral edges 286 that perpendicularly intersect with the longitudinal edges. In other embodiments, the second frame attachment face 256 of the angled adapter 250 can be configured similarly to the planar partition with parallel busbar access apertures for the individual busbars as described above.

To enclose the adapter cavity 252, the adapter canopy 258 can include a first canopy panel 290 attached and perpendicular to the first housing attachment face 254 and a second canopy panel 292 attached and perpendicular to the second attachment face 256. The first and second canopy panels 290, 292 can be generally planar and their orthogonal arrangement can establish the remaining longitudinal faces of the rectangular cube of the angled adapter 250.

The first and second canopy panels 290, 292 can extend toward each other and can intersect at a canopy curvature 294 formed as a rounded, small radius fillet. The canopy curvature 294 is aligned and extends in the lateral direction 112. To further enclose the adapter cavity 252, the adapter canopy 258 can include first and second lateral side panels 296, 298, laterally spaced apart in the lateral direction 112 and perpendicular to the first housing attachment face 254 and the second frame attachment face 256, as well as the first and second canopy panels 290, 292.

In an embodiment, the second canopy panel 292 can be laterally separated into a first subpanel 300 and a second subpanel 302 that are arranged co-planar to each other with respect to the plane established by the forward-aft and the lateral directions 110, 112. The first and second subpanels 300, 302 may be shaped as planar squares and may each be joined along an edge to the canopy curvature 294 forming the intersection with the first canopy panel 290. To separate the first and second subpanels 300, 302, a canopy rut 304 disposed into the second canopy panel 292 and arranged to extend along the forward-aft direction 110. To accommodate fasteners for mounting the angled adapter 250 to the box frame, a plurality of fastener openings 306 are disposed through the second frame attachment face 256, including one laterally aligned with the canopy rut 304.

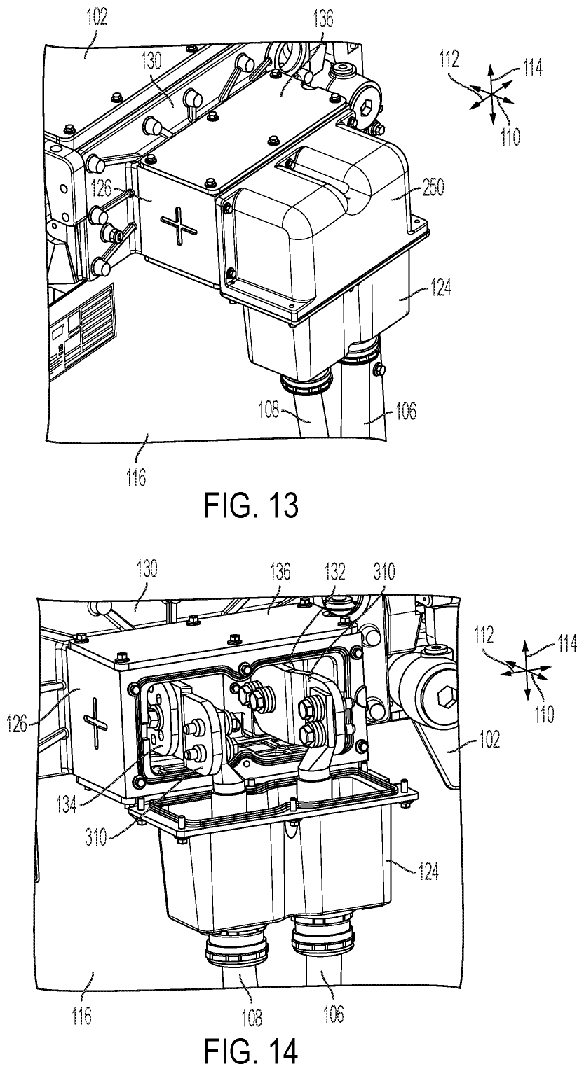

Referring to FIG. 13, when the angled adapter 250 is interposed between the cable receiving housing 124 and the box frame 126, the cable receiving housing 124 is oriented so the first and second cable glands 120, 122 attached thereto are aligned and directed in the vertical direction 114. Moreover, the first and second cable glands 120, 122 are arranged normal to and offset from the mounting plate 130 mounted to the planar casing panel 116 of the battery pack 102 through which the bus bar terminals may protrude. The angled adapter 250 thus alters the direction of the electrical connection established between the electrical cables and the busbar terminals.

### INDUSTRIAL APPLICABILITY

Referring particularly to FIG. 4, and with continued reference to the other proceeding figures, the electrical connector 100 can be selectively configured to align the electrical cables 106, 108 into electrical connection with the first and second busbar terminals 132, 134 from multiple directions. The box frame 126 is mounted to the elevated mounting boss 202 on the mounting plate 130 from which projects the first and second busbar terminals 132, 134 in the forward-aft direction 110. The first and second busbar terminals 132, 134 can project through the first and second busbar access apertures 182, 184 in the mounting face 176 and into the terminal receiving cavity 128 defined by the box frame 126.

To establish the electrical connection, the first and second electrical cables 106, 108 are directed into the cable receiving housing 124 by insertion through the first and second cable ports 154, 156 disposed in the planar shell face 152 thereof. In an embodiment, cable glands 120, 122 such as those shown in FIGS. 1-3 can be used to secure and seal the electrical cable 106, 108 with respect to the cable receiving housing 124.

The distal ends to the electrical cables 106, 108 can extend through the shell cavity 144 defined by the receptacle shell 142 and can be directed into the terminal receiving cavity 128 defined by the box frame 126 via one of the access openings 180 defined by the first, second or third frame faces 170, 172, 174. The electrical cables 106, 108 can be electrically connected with the busbar terminals 132, 134 located in the terminal receiving cavity 128, for example, by conductive fasteners in order to establish a highly conductive connection.

The access aperture 180 through which the electrical cables 106, 108 are directed can be selected from the plurality of the first, second and third frame faces 170, 172, 174 depending upon which direction the electric cables are aligned with the box frame 126 mounted to the battery pack. For example, if the electrical cables are aligned in the forward-aft direction 110, the cables can enter the access opening 180 of the first frame face 170 that is perpendicular to forward-aft direction 110. Alternatively, if the electrical cables 106, 108 are approaching the box frame from the vertical direction 114, either upwards or downwards, the cables can enter the access openings 180 of the second or third frame faces 172, 174 that are perpendicular and exposed with respect to the vertical direction 114.

Depending upon the access opening 180 through which the electrical cables 106, 108 are directed, the cable receiving housing 124 can be placed adjacent to and attached to the corresponding one of the first, second or third frame faces 170, 172, 174. For example, the peripheral attachment rim 140 can be placed adjacent to the planar exterior surface of the frame face 170, 172, 174 and attached thereto by, for example, fasteners. The first and second cable ports 154, 156 that are disposed through the planar shell face 152, which is parallel to the peripheral attachment rim 140, are directed in alignment with the access opening 180 by the structural rigidity of the cable receiving housing 124.

To cover the access openings 180 of the frame faces 170, 172, 174 that remain uncovered after attachment of the cable receiving housing 124 to the box frame 126, the cover plates 136 can be place adjacent to the respective frame faces and secured thereto with fasteners. Prior to being enclosed with the cover plates 136, the access openings 180 can provide access to the terminal receiving cavity 128 to facilitate securing the electrical cables 106, 108 with the busbar terminals 132, 134 located in the box frame 126.

To render the electrical connection environmental impermeable, prior to attachment of the cable receiving housing 124 and the cover plates 136, compressible elastomeric seals can be placed into the seal grooves 186. To further improve the enclosure of the electrical connector 100, the check plates 230 can be snap fit into the access opening 180 of the respective frame faces 170, 172, 174 prior to attachment of the cover plates 136.

Referring to FIGS. 13 and 14, in the embodiment wherein the electrical connection 100 includes an angled adapter 250, the direction of the electric connection between the electrical cables 106, 108 and the busbar terminals 132, 134 is altered approximately 90°. For example, the busbar terminals 132, 134 can project normally through the mounting plate 130 mounted on the planar casing panel 116 in the forward-aft direction 110 and the first and second high powered electrical cables 106, 108 are aligned in the vertical direction 114 by the orientation of the cable receiving housing 124. The busbar terminals 130, 132 can be protectively accommodated in the terminal receiving cavity 128 of the box frame 126 and the cables can extend into the shell cavity 144 of the cable receiving housing 124. The terminal receiving cavity 128 and the shell cavity 144 are interconnected by the angled adapter 250 and the adapter cavity defined therein.

In an embodiment, to accommodate the additional volume occupied by the angled adapter 250, the electrical connector 100 can include a pair of terminal extensions 310. The terminal extensions 310 can be made of a conductive metal and can be secured by, for example, fasteners to the first and second busbar terminals 130, 132 accommodated in the terminal receiving cavity 128 of the box frame 126. The terminal extensions 310 can align and extend in the forward-aft direction 110 and can therefore project into the region defined by the adapter cavity juxtaposed between the cable receiving housing 124 and the box frame 126. The terminal extensions 310 therefore extend the spatial offset from the battery casing 104 resulting from including of the angled adapter 250 into the electrical connector 100. Further, the terminal extensions 310 can avoid having to sharply bend or re-orientate the electrical cables 106, 108 through the orthogonal redirection enabled by the angled adapter 250 to complete the electrical connection to the busbar terminals 130, 132.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

The use of the terms “a” and “an” and “the” and “at least one” or the term “one or more,” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B” or one or more of A and B″) is to be construed to mean one item selected from the listed items (A or B) or any combination of two or more of the listed items (A and B), unless otherwise indicated herein or clearly contradicted by context.

Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

We claim:

1. An electrical connector for high voltage connection of electrical cables to a battery pack, the electrical connector comprising:
a box frame defining a terminal receiving cavity and including at least a first frame face having a first access opening to the terminal receiving cavity disposed therein;
a cable receiving housing including a first cable port and a second cable port for receiving electrical cables, the cable receiving housing attachable to the first frame face to direct the electrical cables into the terminal receiving cavity.

2. The electrical connector of claim 1, wherein the box frame further includes a second frame face having a second access opening to the terminal receiving cavity disposed therein, and the cable receiving housing attachable to second frame face.

3. The electrical connector of claim 2, wherein the box frame further comprising a mounting face having a first terminal access aperture and a second terminal access aperture disposed through to the terminal receiving cavity.

4. The electrical connector of claim 3, wherein the box frame is shaped as a cubic rectangle and the first frame face and the second frame face are orthogonal.

5. The electrical connector of claim 4, wherein the box frame further includes a third frame face that is arranged orthogonal to the first frame face and parallel to the second frame face, the third frame face including a third access opening disposed therein.

6. The electrical connector of claim 5, wherein the first frame face, the second frame face, and the third frame face each include a seal groove disposed into an exterior surface thereof to circumscribe a respective one of the first access opening, the second access opening, and the third access opening.

7. The electrical connector of claim 6, further comprising a cover plate attached to one of the first frame face and the second frame face to cover one of the first access opening and second access opening therein respectively.

8. The electrical connector of claim 1, wherein the cable receiving housing includes a receptacle shell defining a shell cavity accessible through the first cable port and the second cable port.

9. The electrical connector of claim 8, wherein the receptacle shell protrudes from a peripheral attachment rim adapted to adjacently abut the first frame face and the second frame face.

10. The electrical connector of claim 9, wherein the receptacle shell further includes a shell skirt that extends from the peripheral attachment rim to a planar shell face in which the first cable port and the second cable port are disposed and parallel with the peripheral attachment rim.

11. The electrical connector of claim 10, wherein the receptacle shell further includes a first cubic lobe and a second cubic lobe joined at a shell neck, the first cubit lobe associated with the first cable port and a second cubic lobe associated with the second cable port.

12. The electrical connector of claim 1, further comprising a mounting plate having a planar case surface for adjoining a battery case and an elevated mounting boss for adjoining a mounting face of the box frame.

13. The electrical connector of claim 12, wherein the mounting plate further includes a first terminal slot and a second terminal slot disposed between the planar case surface and the elevated mounting boss.

14. The electrical connector of claim 1, further comprising a check plate having a planar structure and adapted for installation in the access opening.

15. The electrical connector of claim 1, further comprising an angled adapter having a housing attachment face adapted to attach to the cable receiving housing and a frame attachment face adapted to attach to the box frame, the housing attachment face and the frame attachment face arranged orthogonal to each other.

16. The electrical connector of claim 15, wherein the angled adapter defines an adapter cavity between the housing attachment face and the frame attachment face.

17. The electrical connector of claim 16, wherein the housing attachment face defines a first adapter opening to the adapter cavity and the frame attachment face defines a second adapter opening to the adapter cavity.

18. The electrical connector of claim 17, wherein the angled adapter includes an adapter canopy extending between the housing attachment and the frame attachment face.

19. The electrical connector of claim 18, wherein the adapter canopy includes a first canopy panel joined perpendicularly to the mounting face and a second canopy panel joined perpendicularly to first frame face, the first canopy panel and the second canopy panel intersecting at a canopy curvature.

20. A method of establishing an electrical connection to a battery back comprising:
mounting a box frame defining a terminal receiving cavity therein to a battery casing of the battery pack to accommodate a first battery terminal and a second battery terminal within the terminal receiving cavity;
inserting a first electrical cable and a second electrical cable respectively through a first cable port and a second cable port located in a cable receiving housing;
inserting the first electrical cable and the second electrical cable into the terminal receiving cavity through an access opening defined in a first frame face on the box frame;
connecting the first electrical cable and the second electrical cable respectively to the first battery terminal and the second battery terminal; and
attaching the cable receiving housing to the first frame face to align the first electrical cable and the second electrical cable into the terminal receiving cavity.

21. The method of claim 20, further comprising attaching a cover plate to cover a second access opening disposed in a second frame face of the box frame.

22. The method of claim 21, wherein the step of attaching the cover plate further compresses a seal within a sealing groove disposed in the second frame face.

23. A battery pack comprising:
a battery casing enclosing electrical chemical cells of the production of electricity;
a first busbar terminal and a second busbar terminal protruding externally from the battery casing;
an electrical connector enclosing an electrical connection between a first electrical cable and a second electrical cable with respectively the first busbar terminal and the second busbar terminal, the electrical connector including:
a box frame mounted to the battery casing to accommodate the first busbar terminal and the second busbar terminal in a terminal receiving cavity defined by the box frame and accessible through an access opening disposed in a first frame face; and
a cable receiving housing mounted to the first frame face of the box frame, the cable receiving housing include a first cable port and a second cable port for insertion and alignment of the first electrical cable and the second electrical cable with respectively the first busbar terminal and the second busbar terminal accommodated in the terminal receiving cavity.

24. The battery pack of claim 23, further comprising a cover plate attached to cover a second frame face of the box frame.

25. The battery pack of claim 24, wherein the box frame is a shaped as a cubic rectangle and the first frame face of the box frame is arranged in one of a parallel orientation and a perpendicular orientation with respect to the battery casing.

26. The battery pack of claim 25, wherein the cable receiving housing includes a receptacle shell defining a shell cavity accessible through the first cable port and the second cable port.

27. The battery pack of claim 26, further comprising an angled adapter including a housing attachment face adapted for attachment to the cable receiving housing and a frame attachment face adapted for attachment to the box frame, the housing attachment face and the frame attachment face orthogonal to each other.

28. The battery pack of claim 27, wherein the box frame further includes an adapter canopy extending between the housing attachment face and the frame attachment face.
